(19) United States
(12) Patent Application Publication
(10) Pub. No.: US 2016/0142294 A1
(43) Pub. Date: May 19, 2016

(54) Gx-Rx BINDING WITH AN ALTERNATE TO APN

(71) Applicant: Alcatel-Lucent Canada, Inc., Ottawa (CA)

(72) Inventors: Robert A. Mann, Carp (CA); Kugendran Sabaratnam, Kanata (CA); Matthew A. Yee, Kanata (CA)

(21) Appl. No.: 14/546,843

(22) Filed: Nov. 18, 2014

(51) Int. Cl. H04L 12/721; H04L 12/725

(52) U.S. Cl. CPC H04L 45/44; H04L 45/304

(57) ABSTRACT

Various exemplary embodiments relate to a method of routing Diameter messages in a network, the method including defining an alternate Attribute Value Pair (AVP) comprising a name and a format, wherein the alternate AVP indicates a session identity to enable route matching; determining a rule comprising the alternate AVP; and storing the rule.

### TECHNICAL FIELD

Various exemplary embodiments disclosed herein relate generally to matching or binding telecommunications network system messages from different types of devices.

### BACKGROUND

Telecommunications networks use standardized protocols such as Diameter to communicate between network nodes. Even within each of these protocols, different devices and applications may use different message formats to communicate information to other devices or applications within and across networks. For example, a Diameter packet consists of a Diameter header and a variable number of Attribute-Value Pairs (AVPs) for encapsulating information relevant to the Diameter message; different types of Diameter messages may include different AVPs. A key may be used when these different types of messages and their corresponding data are matched. The key may be generated and/or derived from header and/or AVP information within the messages.

### SUMMARY

In light of the present need for a flexible method of routing Diameter messages using alternate unique identifiers, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of routing Diameter messages in a network, the method including defining an alternate Attribute Value Pair (AVP) comprising a name and a format, wherein the alternate AVP indicates a session identity to enable route matching; determining a rule comprising the alternate AVP; and storing the rule. Alternative embodiments further include receiving a Diameter message; determining the Diameter message contains the alternate AVP; extracting a value from the alternate AVP; and storing the alternate AVP value, an IP address, and a session identifier. Additional embodiments further include determining the session identifier based upon the alternate AVP value and the IP address. Further embodiments include determining a destination based upon the session identifier. In further embodiments, determining a destination based upon the session identifier includes performing a lookup in a Diameter Routing Agent (DRA) database.

In alternative embodiments the rule further includes a message type, and the method further comprises determining the Diameter message is the message type. In other embodiments the rule further includes a message type, and the method further includes determining the Diameter message is not the message type; determining the Diameter message contains a default alternate AVP; extracting a value from the default alternate AVP; and storing the default alternate AVP value, an IP address, and a session identifier.

In alternative embodiments the method further includes receiving a Diameter message; extracting a value from the Diameter message; appending the value to the Diameter message in the format as the alternate AVP; and sending the message to a network node. In some embodiments the rule further includes a message type, and the method further includes determining the Diameter message is the message type. In various embodiments the value further includes an Access-Point-Name (APN) value. In some embodiments the value further includes a subscriber ID value. In other embodiments the step of sending the message to the network node further includes determining the network node based upon the alternate AVP and an IP address.

Various exemplary embodiments relate to a first network node for routing Diameter messages in a network, the first network node including a network interface configured to communicate with other nodes in a network; a memory; and a processor in communication with the network interface and the memory, the processor configured to define an alternate Attribute Value Pair (AVP) comprising a name and a format, wherein the alternate AVP indicates a session identity to enable route matching; determine a rule comprising the alternate AVP; and store the rule. In alternative embodiments, the processor is further configured to receive a Diameter message; determine the Diameter message contains the alternate AVP; extract a value from the alternate AVP; and store the alternate AVP value, an IP address, and a session identifier. In some embodiments the processor is further configured to determine the session identifier based upon the alternate AVP value and the IP address. In some embodiments the processor is further configured to determine a destination based upon the session identifier. In other embodiments the processor is further configured to, when determining a destination based upon the session identifier, perform a lookup in a Diameter Routing Agent (DRA) database.

In alternative embodiments the rule further comprises a message type, and the processor is further configured to determine the Diameter message is the message type. In other alternative embodiments the processor is further configured to determine the Diameter message is not the message type; determine the Diameter message contains a default alternate AVP; extract a value from the default alternate AVP; and store the default alternate AVP value, an IP address, and a session identifier. In some alternative embodiments the processor is further configured to receive a Diameter message; extract a value from the Diameter message; append the value to the Diameter message in the format as the alternate AVP; and send the message to a second network node.

It should be apparent that, in this manner, various exemplary embodiments enable flexible routing of Diameter messages using alternate identifiers. In particular, by producing rules for using and storing alternate unique identifiers within Diameter messages to route the messages to the appropriate nodes.

### BRIEF DESCRIPTION OF THE DRAWINGS

In order to better understand various exemplary embodiments, reference is made to the accompanying drawings, wherein:

FIG. 1 illustrates an exemplary network environment for a Diameter Routing Agent;

FIG. 2 illustrates an exemplary system for routing Diameter messages;

FIG. 3 illustrates a method by which an alternate unique identifier may be used to distinguish between conflicting IP addresses within a network;

FIG. 4 illustrates an exemplary hardware diagram for a device used to route Diameter messages.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or” refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein. Further, while various exemplary embodiments are described with regard to Diameter message routing, it will be understood that the techniques and arrangements described herein may be implemented to facilitate network messaging in other types of systems that implement multiple types of data processing or data structure.

Referring now to the drawings, in which like numerals refer to like components or steps, there are disclosed broad aspects of various exemplary embodiments.

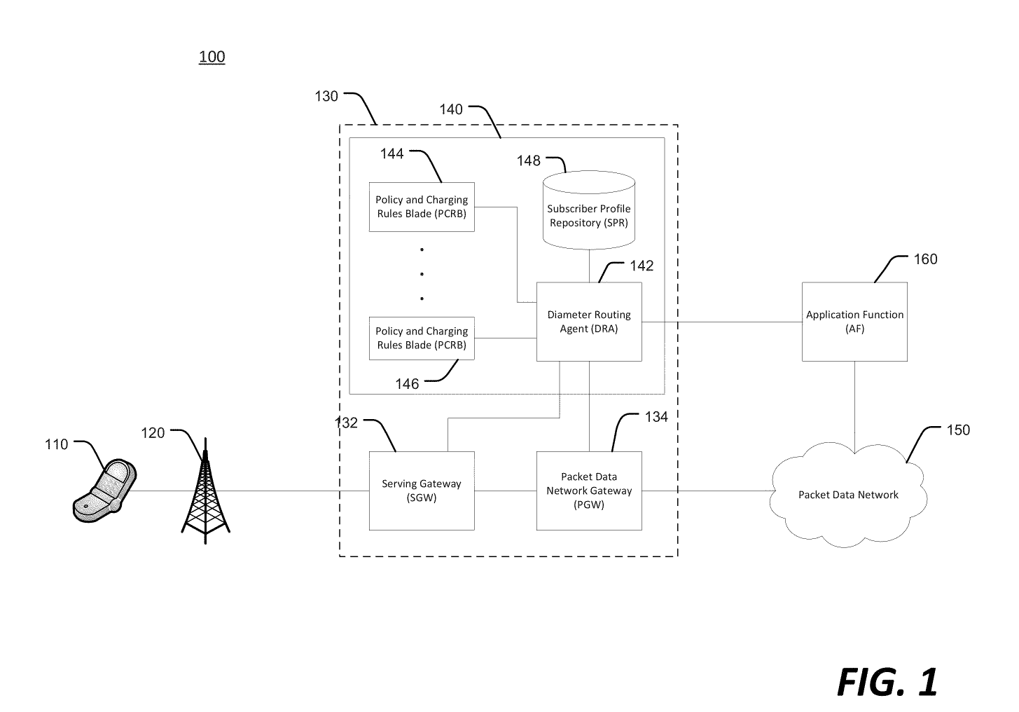

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, packet data network 150, and application function (AF) 160.

User equipment 110 may be a device that communicates with packet data network 150 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository.

DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with AF 160 via an Rx interface. As described in further detail below with respect to AF 160, PCRB 144, 146 may receive an application request in the form of an Authentication and Authorization Request (AAR) from AF 160. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 138 may include subscriber information such as identifiers for each subscriber, bandwidth limits, charging parameters, and subscriber priority.

Packet data network 150 may be any network for providing data communications between user equipment 110 and other devices connected to packet data network 150, such as AF 160. Packet data network 150 may further provide, for example, phone or Internet service to various user devices in communication with packet data network 150.

Application function (AF) 160 may be a device that provides a known application service to user equipment 110. Thus, AF 160 may be a server or other device that provides, for example, a video streaming or voice communication service to user equipment 110. AF 160 may further be in communication with the PCRB 144, 146 of the EPC 130 via an Rx interface. When AF 160 is to begin providing known application service to user equipment 110, AF 160 may generate an application request message, such as an authentication and authorization request (AAR) according to the Diameter protocol, to notify the PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within subscriber network 100 and supported by DRA 142. For example, an Rx application may be established between AF 160 and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

Different types of Diameter messages sent by different devices within a telecommunications network may include different AVPs; a key generated and/or derived from header and/or AVP information within the messages may be used when these different types of messages and their corresponding data are matched. For example, a Policy and Charging Rules Function (PCRF) may be a node that administers the policy and charging domain within the network by determining policy rules in real-time. Within the policy and charging domain, there may be at least two Diameter applications supported by the PCRF, and each application may use different Diameter message types. Gx may be used for messages to and from gateways in the network and Rx may be used for messages to and from AFs. AF messages may be sent to the PCRF to request service for subscribers. To allow the service the PCRF may send messages over Gx to the gateways. As such, at different points within the policy and charging domain some form of binding must be done to determine the destination of each Gx Session so that corresponding Rx Session messages may be routed appropriately.

A key may be used when these different types of messages and their corresponding session data are matched in the PCRF database, where the binding information may be used as a foreign key for each IP-CAN session representing a subscriber on the network. For each IP-CAN session there may be many related AF sessions, charging sessions, etc.; each AF Session may include a foreign key pointing to the subscriber's IP-CAN Session. In an alternative implementation, all of the session information for each subscriber session in the database may be bound together in a single record (including IP-CAN information, AF information, Gateway info, etc.). In some cases, the IP address of the session/message may be used as a key, however, the IP address may not suffice as a unique key in larger networks, where the service provider may have overlapping address pools because they may not have a sufficiently large number of unique addresses available for their customer base. The 3GPP standard (29.214) allows the use of the Called-Station-Id AVP (also known as Access-Point-Name (APN) or packet data network (PDN)) as a second piece of data to distinguish between two IP addresses that are the same, such that the combination of the IP address and the APN becomes the key. Therefore, an address 1.2.3.4+APN_1 may be different than address 1.2.3.4+APN_2. According to the standard, other pieces of information, for example, subscriber identity, may also be used as an additional unique identifier to match different types of messages, however, even though in the Gx protocol each gateway obtains identity from the subscriber's device (e.g. cellphone), other application functions (AFs) may not have access to subscriber identity; rather, they may include a SIP identity or other form of identity information. Therefore, in many implementations, other than the APN AVP, no single intersecting piece of identifying information may be included in different message types such that messages may be matched based on a unique key generated from the identifying information.

In some instances a network provider with overlapping IP address pools may also have a standard APN value at all sites in the network deployment. For example, the APN may be used for rule logic, for example, to indicate whether the Diameter message is carrying voice or data traffic. In such instances, the APN value may not be used as an additional key to distinguish overlapping addresses. In addition, the APN data in the messages may not be tampered with in order to provide matching functionality, because the APN value may be used in other network functions that provide customer services which would be negatively affected if the APN value were changed in the policy and charging domain. As such, in networks configured with a standard APN value at all sites, nodes that perform different functions and rely on the Diameter protocol to communicate in a standardized manner would not be able to derive a key using information in the APN as indicated by the Diameter standard.

The lack of a standard unique key between nodes communicating in the Diameter protocol is problematic because different nodes within the policy and charging domain rely on the binding function, for example: a PCRF may perform the actual binding of Gx and Rx sessions, a common service blade (CSB) may perform message binding in order to determine to which specific PCRF node an Rx request message should be forwarded such that the request message goes to the PCRF where the corresponding Gx session resides (for example, to differentiate different pools of addresses of PCRFs), and a Diameter Routing Agent (DRA)/Diameter Control Point (DCP) may perform binding in order to determine the correct CSB to forward an Rx request. The binding and lookup logic of the DRA/DCP, CSB and the PCRF may be similar and depend upon the Diameter binding standard. Note that the standard specifies many different ways to perform the binding function and the lookup function. For example, the binding may be performed by matching subscriber identity, where there may be many different subscriber identity values within a message. As another example, lookups may be performed based on a variety of different values, including the Diameter Session ID value; IPv4 address, IPv6 prefix, and APN.

In view of the foregoing, it would be desirable to have an alternative AVP to bind different messages of different types such as Gx and Rx messages. In particular, it would be desirable to have a common yet configurable binding scheme across different types of network devices, that nevertheless is an extension of a standard Diameter implementation.

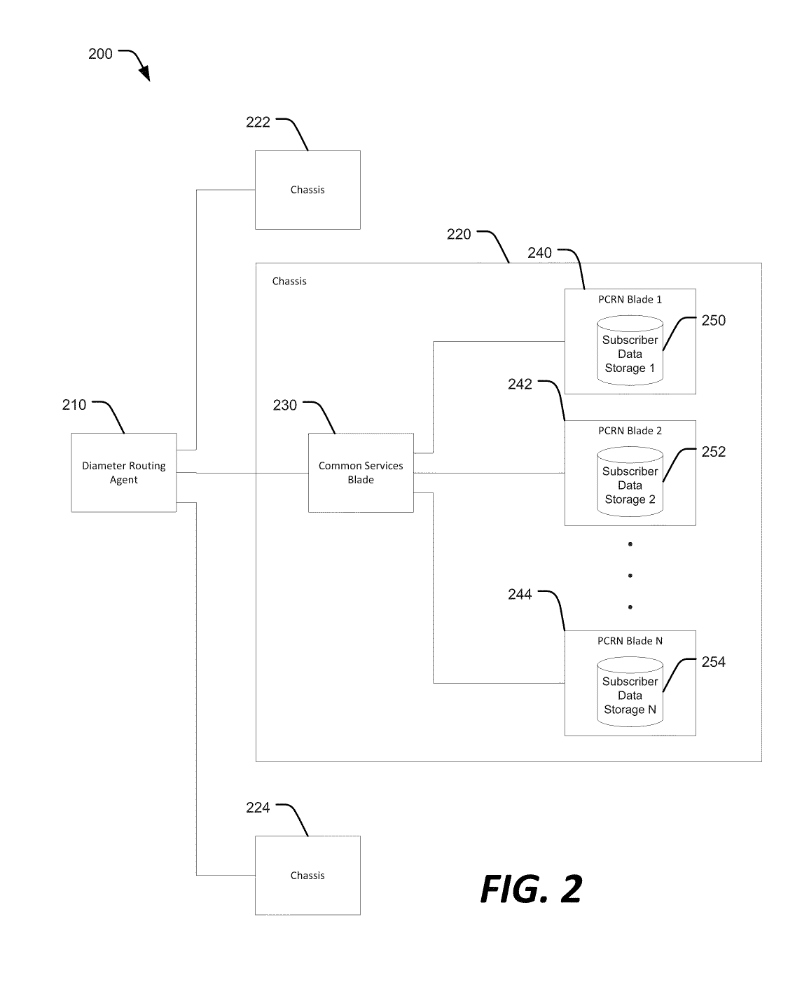

FIG. 2 illustrates an exemplary system 200 for routing Diameter messages using unique identifiers. DRA 210 may correspond to DRA 142 in FIG. 1. DRA 210 may function as a front-end to system 200, a point of contact that Gateways and Application Functions have the PCRF systems. Diameter messages may be received by a DRA 210 and routed to a CSB such as CSB 230 within one or more chassis 220, 222, 224, where each chassis may contain one or more Policy and Charging Rules Nodes (PCRNs) such as PCRNs 240, 242, 244 that may include a PCRF. Each PCRN may be allocated one or more pools of IP addresses, where different PCRNs may be allocated the same IP address.

CSB 230 may receive messages from a DRA such as DRA 210 and route each message to a PCRN 250, 252, 254. Each of the multiple PCRNs 250, 252, 254 may be provisioned its own group of subscribers. For example, PCRN 240 may be allocated subscribers A₁, A₂, through A_{N} in data storage 250, PCRN 242 may be allocated subscribers B₁, B₂, through B_{N} in data storage 252, and PCRN 244 may be allocated subscribers X₁, X₂, through X_{N} in data storage 254. As noted above, different subscribers may be allocated the same IP address within different IP pools. Under the 3GPP standard, a subscriberID or APN AVP values within a received message and recorded for each subscriber within data storage 250, 252, 254 may be used to differentiate between two subscribers allocated the same IP address. As an example, subscriber A₁ and subscriber B₁ may have the same IP address, but different APN values, and thus, since CSB 240 may not have access to subscriber identities in a message, and so would use the IP address and in addition an APN value for each subscriber in order to route messages to the correct PCRN, 240, 242, through 244.

As described above, the 3GPP standard indicates that two values, the IP address plus another unique identifier of a subscriber, may be used by a DRA 210, CSB 230, and PCRN 240, 242, 244 for purposes of routing Diameter messages to the correct subscriber allocated to a PCRN. As noted above, both a unique APN value and a subscriber ID may be unavailable for routing purposes.

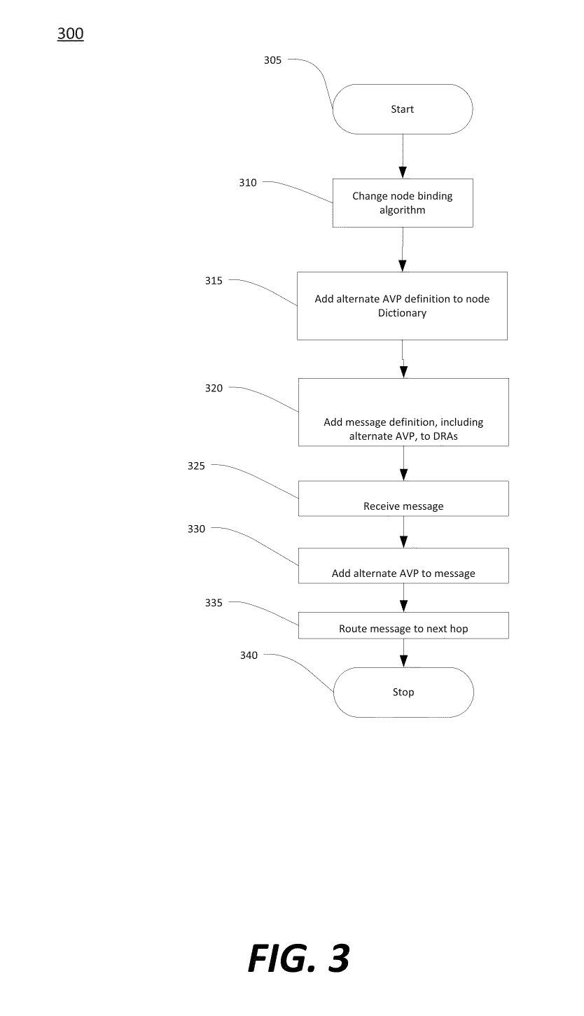

FIG. 3 illustrates a method by which an AVP other than the APN AVP or a subscriber ID may be used to distinguish between conflicting IP addresses. The method may start at 305. In a first step 310, the binding algorithms in a node, such as, for example, a PCRF (e.g. within a PCRN 240, 242, or 244), CSB (such as CSB 230), and DRA (such as DRA 210) may be changed such that an AVP other than the APN AVP may optionally be used to distinguish between conflicting IP addresses. For example, an alternate source for the APN value may be specified as a system property in an administrator interface for the node (e.g. a graphical user interface (GUI) or an application programming interface (API)), or by altering configuration files within the node. In Diameter messages, an AVP may be identified by a name—for example, an APN AVP may be called “Called-Station-Id” as described above. In one embodiment, an alternate APN may be named by a default value as a global system default. In another embodiment, each type of node, e.g. PCRF CSB, or DRA, may have its own default name for an alternate AVP. In some embodiments, the default name of the alternate AVP each node or all nodes may be overridden by an administrator through an interface or by a configuration in a configuration file for the node. An alternate AVP may use one or more message values for binding an IP address to another value to create a unique identifier as an alternative to APN, for example, origination host, IP address of the original destination, peer route—the message values used as unique identifiers may, for example, indicate to which portion (segment, partition, subnet, etc.) of the network the destination IP Address belongs. Thus, a node may use the value in the identifying segment to indicate in the alternate AVP to which network segment/partition/subnet the IP Address should be routed, for example to Chassis 220, CSB 230, or PCRN 240, 242, or 244. Once the name property of an alternate APN has been set in a node in step 310, if the named AVP occurs in a Diameter request received by the node the binding logic within the node will recognize the alternate AVP as the uniquely identifying value when matching the IP address of Gx and Rx sessions, rather than using the APN AVP value as required by the 3GPP standards.

In another step 315, a definition of the alternate AVP may be added to the Diameter Dictionary of the node 210, 230, PCRN 240, 242, or 244, including, for example, the name of the alternate AVP, which as indicated above may be a default name, or may be a name designated through an interface or a configuration file. The alternate AVP may be a proprietary AVP, to ensure that the node does not accidentally modify message contents by reusing an existing AVP. In particular, the alternate AVP may not have the same name as an AVP already used to store the APN value, because as noted, the APN value may have a service function that may be disrupted if the value is altered.

In another step 320, the definitions of the appropriate Diameter request messages, including Gx CCR and Rx AAR messages, may be modified on affected DRAs, such as DRA 210, to include the alternate AVP. Alternately, an AVP parenting feature, for example, as described in application no. U.S. Pat. No. 8,850,064, herein incorporated by reference for all purposes, may be used to specify that the alternate AVP may be present in Gx CCR and Rx AAR messages. Thus, the alternate AVP may be accessed when processing rules are written or edited. In some embodiments, different message types may be associated with different alternate AVPs, for example, one named alternate AVP may be used on one message type, such as Gx messages, and another differently named and/or formatted message type may be used for another message type, such as Rx messages. Further, the values of different alternate AVPs may be derived from different message elements, for example, origin host or destination host as described above. Thus, steps 315 and 320 may be repeated for each alternate AVP and message type handled by the node. Although message types and names may differ, any value used as an alternate AVP will be, when combined with an IP address, matchable to a unique subscriber session, except that in some implementations a combination of alternate AVPs and an IP address may be combined; or, in some alternative embodiments, the alternate AVP itself may be an IP address and identifying information combined. In addition, in some implementations the matching algorithm may be further altered so that if the alternate AVP value may not be used to create a proper match, the value may be altered, for example, by removing a prefix or performing a hash function, to determine a match. In another example, which type of match is performed may be determined based on context, for example, based upon origin or destination realm. Because DRA 210 may function as a front-end for Gateways and Application Functions, a distinguishing piece of data may be added to messages received by a DRA 210 if it has not been added before receipt of the message by the DRA 210.

Steps 305 through 320 may occur during the startup or initialization of system 200 or individual nodes 210, 230, 240, 242, 244, such that node logic is altered so the APN AVP is no longer used to determine message destination identity, rather each node will examine incoming messages for a string matching the “new” alternate AVP, and if the string is present, it will be used, with the IP address of the destination device, as a unique identifier—in operation, as discussed below, when a message arrives, the alternate AVP will be used for purposes of identity.

For example, in step 325, a Gx or Rx request destined for a PCRF 240, 242, through 244, may be received, and the alternate AVP added 330 to requests before they are routed by the DRA 210 to the next hop 335. The value of the alternate AVP set in step 330 may be based on criteria such as, but not limited to: the Origin-Host or Origin-Realm of the device that sent the request, the local IP address of the DRA that the request arrived on, the Diameter identity of the peer that the request arrived through, and/or the route the request took to get to the DRA (as indicated by the values of the entries in the Route-Record AVP). Note that in some embodiments, if the AVP has a different name at different nodes, at step 330, in each node, other than the DRA, the alternate AVP may be derived from the received message and added with the same value but a different name, namely, the name relative to the receiving node, before transmission to the next node in step 335. In other embodiments, where the name of the AVP is the same across types of system nodes, each node will be configured (through an interface or configuration file) to use the alternate AVP as the source of identifying data, and once added by the DRA 210, the alternate AVP may be included at each node (such as CSB 230 or PCRN 250) without renaming and insertion into the message at step 330. As described above, in such an embodiment, the name of the alternate AVP may be set as a global default across system 200 such that all nodes are configured to use, in combination with the subscriber device IP address, the named alternate AVP as the source for unique identifying information, rather than the APN AVP as described in the 3GPP standard. The method may stop at step 340.

Once the alternate AVP has been defined such that DRA 210, CSB 230 and PCRN 240, 242, through 244 have been configured to use the alternate AVP rather than the APN AVP to route messages, the binding algorithm the nodes may automatically use the alternate AVP to uniquely distinguish conflicting IP addresses, and the other existing routing/binding functionality of the DRA 210, CSB 230 and PCRNs 240, 242, through 244 may work as previously configured, just with a different piece of data named for the uniquely identifying data in addition to the subscriber IP address. For example, in the case of a Gx-Attach, the message will arrive at a DRA 210 and flow through the system 200 to a PCRN 240, 242, or 244, consistent with the Diameter standard, but with the alternate AVP replacing the APN AVP as a unique identifier, and, assuming that establishing the Gx session is a success, a Gx-CCA establish message will be returned to the DRA 210, which will store the IP Address and alternate AVP as an identifier for the session established for that IP address, and a record that the session was sent to a particular PCRF system (again, consistent with the Diameter standard). The key that would be stored would be a combination of the alternate AVP value, plus the IP address. Subsequently, upon arrival at the DRA of an Rx establish message, rule logic will process the identity data in the message such as information in the AVPs and Diameter header of the message to determine an existing destination mapping (or determine that none exists). The logic will extract the information from the alternate AVP plus the IP address, and use that as the key to find the existing destination mapping.

In another example, the CSB 230 may examine an incoming request, determine that there is no destination host, and perform a lookup on the DRA database to determine a mapping of which PCRN 240, 242, through 244 to send the message to, based on the IP Address and alternate AVP value. The CSB may store the mapping of the establishment of the session such that when the establish message is received, the PCRF may bind the Gx/Rx mapping information together, and when the answer is received, the CSB may store the binding information, and return a message to the DRA which may store the binding information. So, now each node may have mapping data for the alternate AVP so that when an Rx message is received, each device may perform a lookup to find the corresponding match.

Because AVP names and values may be configurable, different implementations may use different alternate AVP names and formats, or use multiple AVPs, for example, may use a default alternate AVP and an additional alternate AVP for different types of identifiers or for different formats. For example, different providers may use different alternate AVPs, or may use a default alternate AVP specified by a system provider.

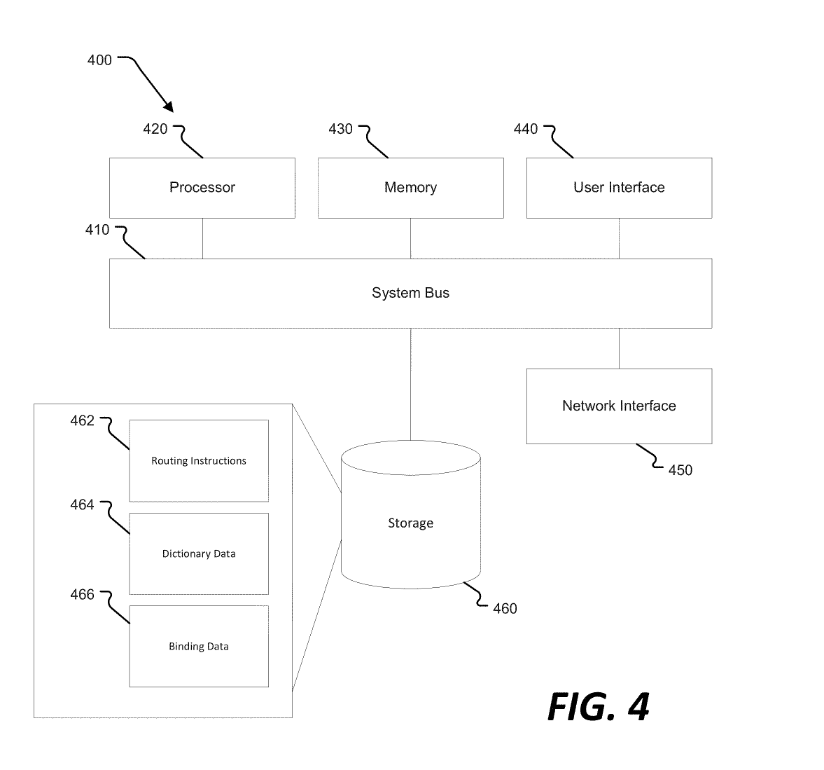

FIG. 4 illustrates an exemplary hardware diagram for a device 400 such as device including a node of system 200. The exemplary device 400 may correspond to a PCRN 240, 242, 244, CSB 230, or DRA 210 of FIG. 2. As shown, the device 400 includes a processor 420, memory 430, user interface 440, network interface 450, and storage 460 interconnected via one or more system buses 410. It will be understood that FIG. 4 constitutes, in some respects, an abstraction and that the actual organization of the components of the device 400 may be more complex than illustrated.

The processor 420 may be any hardware device capable of executing instructions stored in memory 430 or storage 460. As such, the processor may include a microprocessor, field programmable gate array (FPGA), application-specific integrated circuit (ASIC), or other similar devices.

The memory 430 may include various memories such as, for example L1, L2, or L3 cache or system memory. As such, the memory 430 may include static random access memory (SRAM), dynamic RAM (DRAM), flash memory, read only memory (ROM), or other similar memory devices.

The user interface 440 may include one or more devices for enabling communication with a user such as an administrator. For example, the user interface 440 may include a display, a mouse, and a keyboard for receiving user commands.

The network interface 450 may include one or more devices for enabling communication with other hardware devices. For example, the network interface 450 may include a network interface card (NIC) configured to communicate according to the Ethernet protocol. Additionally, the network interface 450 may implement a TCP/IP stack for communication according to the TCP/IP protocols. Various alternative or additional hardware or configurations for the network interface 450 will be apparent.

The storage 460 may include one or more machine-readable storage media such as read-only memory (ROM), random-access memory (RAM), magnetic disk storage media, optical storage media, flash-memory devices, or similar storage media. In various embodiments, the storage 460 may store instructions for execution by the processor 420 or data upon with the processor 420 may operate. For example, the storage 460 may store routing instructions 462 for performing Diameter message routing according to the concepts described herein. The storage may also store Dictionary Data 464 and Binding Data 466 for use by the processor executing the routing instructions 462.

According to the foregoing, various exemplary embodiments provide for flexible routing of Diameter messages based on unique identifying information for each subscriber. In particular, by providing an alternate AVP which may be populated by identifying information extracted from Diameter message header and AVP information.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of routing Diameter messages in a network, the method comprising:
defining an alternate Attribute Value Pair (AVP) comprising a name and a format, wherein the alternate AVP indicates a session identity to enable route matching;
determining a rule comprising the alternate AVP; and
storing the rule.

2. The method of claim 1, the method further comprising:
receiving a Diameter message;
determining the Diameter message contains the alternate AVP;
extracting a value from the alternate AVP; and
storing the alternate AVP value, an IP address, and a session identifier.

3. The method of claim 2, further comprising determining the session identifier based upon the alternate AVP value and the IP address.

4. The method of claim 3, further comprising determining a destination based upon the session identifier.

5. The method of claim 4, wherein determining a destination based upon the session identifier comprises performing a lookup in a Diameter Routing Agent (DRA) database.

6. The method of claim 2, wherein the rule further comprises a message type, and the method further comprises determining the Diameter message is the message type.

7. The method of claim 1 further comprising wherein the rule further comprises a message type, and the method further comprises:
determining the Diameter message is not the message type;
determining the Diameter message contains a default alternate AVP;
extracting a value from the default alternate AVP; and
storing the default alternate AVP value, an IP address, and a session identifier.

8. The method of claim 1, further comprising:
receiving a Diameter message;
extracting a value from the Diameter message;
appending the value to the Diameter message in the format as the alternate AVP; and
sending the message to a network node.

9. The method of claim 8, wherein the rule further comprises a message type, and the method further comprises determining the Diameter message is the message type.

10. The method of claim 8, wherein the value further comprises an Access-Point-Name (APN) value.

11. The method of claim 8, wherein the value further comprises a subscriber ID value.

12. The method of claim 8, wherein the step of sending the message to the network node further comprises determining the network node based upon the alternate AVP and an IP address.

13. A first network node for routing Diameter messages in a network, the network node comprising:
a network interface configured to communicate with other nodes in a network;
a memory; and
a processor in communication with the network interface and the memory, the processor configured to:
define an alternate Attribute Value Pair (AVP) comprising a name and a format, wherein the alternate AVP indicates a session identity to enable route matching;
determine a rule comprising the alternate AVP; and
store the rule.

14. The first network node of claim 13, the processor further configured to:
receive a Diameter message;
determine the Diameter message contains the alternate AVP;
extract a value from the alternate AVP; and
store the alternate AVP value, an IP address, and a session identifier.

15. The first network node of claim 14, the processor further configured to determine the session identifier based upon the alternate AVP value and the IP address.

16. The first network node of claim 15, the processor further configured to determine a destination based upon the session identifier.

17. The first network node of claim 16, the processor further configured to, when determining a destination based upon the session identifier, perform a lookup in a Diameter Routing Agent (DRA) database.

18. The first network node of claim 14, wherein the rule further comprises a message type, and the processor further configured to determine the Diameter message is the message type.

19. The first network node of claim 13, the processor further configured to:
determine the Diameter message is not the message type;
determine the Diameter message contains a default alternate AVP;
extract a value from the default alternate AVP; and
store the default alternate AVP value, an IP address, and a session identifier.

20. The first network node of claim 13, the processor further configured to:
receive a Diameter message;
extract a value from the Diameter message;
append the value to the Diameter message in the format as the alternate AVP; and
send the message to a second network node.
